(19) United States
(12) Patent Application Publication
(10) Pub. No.: US 2025/0216885 A1
(43) Pub. Date: Jul. 3, 2025

(54) METHOD AND APPRATUS WITH VARIABLE PARAMETER EXPRESSION

(71) Applicants: Samsung Electronics Co., Ltd., Suwon-si (KR); UNIST (Ulsan National Institute Of Science And Technology), Ulsan (KR)

(72) Inventors: Hyeonuk SIM, Suwon-si (KR); Mun Gyu SON, Suwon-si (KR); Sugil LEE, Ulsan (KR); Jongeun LEE, Ulsan (KR); Minuk HONG, Ulsan (KR)

(73) Assignees: Samsung Electronics Co., Ltd., Suwon-si (KR); UNIST (Ulsan National Institute Of Science And Technology), Ulsan (KR)

(21) Appl. No.: 18/824,462

(22) Filed: Sep. 4, 2024

(30) Foreign Application Priority Data
Dec. 29, 2023 (KR) 10-2023-0196506

(51) Int. Cl. G06F 1/03; G06F 5/01; G06F 7/02

(52) U.S. Cl. CPC G06F 1/03; G06F 5/01; G06F 7/02; G06F 2101/10

(57) ABSTRACT

Disclosed are a method of expressing a parameter variably and an apparatus for the same. A neural processor apparatus includes: a comparator configured to read a value of a fixed-length exponent of a previously-converted parameter value and obtain mantissa-length information of a mantissa, wherein the mantissa-length information is obtained from a mapping table based on being mapped to the value of the exponent; a shifter configured to read the mantissa of the previously-converted parameter value and use the mantissa-length information to convert a structure of the previously-converted parameter value; and the mapping table, in which the mantissa-length information of the mantissa is mapped to the value of the exponent.

### CROSS-REFERENCE TO RELATED APPLICATIONS

This application claims the benefit under 35 USC § 119 (a) of Korean Patent Application No. 10-2023-0196506, filed on Dec. 29, 2023, in the Korean Intellectual Property Office, the entire disclosure of which is incorporated herein by reference for all purposes.

### BACKGROUND

### 1. Field

The following disclosure relates to a method and apparatus with variable parameter expression.

### 2. Description of Related Art

Number formats used in deep learning quantization include fixed point and floating point formats. Fixed point is a number representation that uses all bits to express the mantissa with an implicit fixed exponent value, and floating point is a number representation that expresses a value with fixed-length exponent and mantissa, where the real number expressed without considering the position of the decimal point and the exponent indicating the position are expressed separately.

Compared to fixed point representation, floating point representation may express a larger range of numbers and have a larger bit range, but may have such a slow computation speed that a separate floating point arithmetic unit is often used.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a neural processor apparatus includes: a comparator configured to read a value of a fixed-length exponent of a previously-converted parameter value and obtain mantissa-length information of a mantissa, wherein the mantissa-length information is obtained from a mapping table based on being mapped to the value of the exponent; a shifter configured to read the mantissa of the previously-converted parameter value and use the mantissa-length information to convert a structure of the previously-converted parameter value; and the mapping table, in which the mantissa-length information of the mantissa is mapped to the value of the exponent.

In the mapping table, the mapping of the mantissa-length information to the value of the exponent may be determined according to a distribution of neural network parameters.

The shifter may be further configured to shift the position of the value of the mantissa based on the mantissa-length information of the mantissa.

The shifter may be further configured to add “0” according to a number of bits allocated to express the previously-converted parameter value.

Based on a method of expressing the previously-converted parameter value, the comparator may be further configured to obtain exponent shift information of a fixed-length real part mapped to a value of the real part of the parameter value, and the shifter may be further configured to shift the value of the real part according to the exponent shift information of the real part.

The shifter may be further configured to sum a value of a decimal part of the parameter value and the value of the real part shifted by the exponent shift information of the real part.

The comparator and the shifter may be configured to read the exponent and the mantissa of the previously-converted parameter from a static random-access memory (SRAM), respectively.

For a multiply and accumulate (MAC) operation, the parameter value with the converted structure and the value of the exponent may be input into an arithmetic unit.

In another aspect, an operating method of a processor apparatus includes: reading parameters of a trained model; based on a distribution of the parameters, determining a mapping table mapping mantissa-lengths to respectively corresponding fixed-length exponents; and based on the mapping table, converting values of the parameters to have a number format including a fixed-length exponent and a variable-length mantissa.

In the mapping table, the mantissa-lengths may be determined according to the distribution of the parameters.

The operating method may further include: recording into a memory the exponent values and the mantissa values of the parameters as converted to the number format.

The converting of the values of the parameters to the number format including the fixed-length exponent value and the variable-length mantissa may include converting remaining values after the first occurrence of a “1” in the variable-length mantissa to the number format.

A non-transitory computer-readable storage medium may store instructions that, when executed by a processor, cause the processor to perform any of the operating methods.

In another general aspect, a processor apparatus includes: one or more processors; a memory; and one or more programs stored in the memory and configured to be executed by the one or more processors to cause the one or more processes to perform a process including: reading parameters of a trained model; based on a statistical distribution of the parameters, determining a mapping table mapping mantissa-lengths to respectively corresponding fixed-length exponents; and based on the mapping table, converting values of the parameters to have a number format including a fixed-length exponent and a variable-length mantissa, wherein the converting is performed according to the values of the parameters.

In the mapping table, the mantissa-lengths may be determined according to the statistical distribution of the parameters.

The process may further include: recording into the memory the exponent values and the mantissa values of the parameters as converted to the number format.

The converting of the values of the parameters to the number format including the fixed-length exponent value and the variable-length mantissa may include converting remaining values after the first occurrence of a “1” in the variable-length mantissa to the number format. Other features and aspects will be apparent from the following detailed description, the drawings, and the claims.

### BRIEF DESCRIPTION OF THE DRAWINGS

FIG. 1 illustrates a format for expressing data values, according to one or more embodiments.

FIG. 2 illustrates a method of converting a parameter by a neural processor apparatus, according to one or more embodiments.

FIG. 3 illustrates a neural processor apparatus for converting a previously-converted parameter back to a form computable by an arithmetic unit, according to one or more embodiments.

FIG. 4 illustrates another neural processor apparatus for converting a previously-converted parameter back to a form computable by an arithmetic unit, according to one or more embodiments.

FIG. 5 illustrates an operation of an arithmetic unit, according to one or more embodiments.

FIG. 6 illustrates a smartphone Application Processor (AP), according to one or more embodiments.

FIG. 7 illustrates another smartphone AP, according to one or more embodiments.

FIG. 8 illustrates a processor apparatus for converting a parameter, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

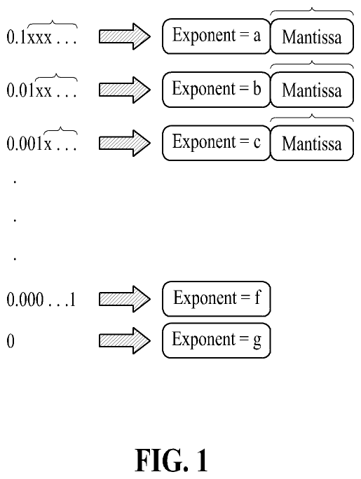

FIG. 1 illustrates a format for expressing data values, according to one or more embodiments.

The number format described below is a general-purpose number format with a diverse range of expressions. The number format may have the form as shown in FIG. 1. The number format may be expressed in the form of a floating point, where the length of the exponent is fixed and the mantissa-length of the mantissa is variable. Depending on the exponent value, the mantissa-length of the mantissa may be determined to be a mapped mantissa-length (e.g., a mantissa-length mapped to the exponent in a mapping table).

A mapping table may be determined depending on the range and space of a set of data values to be expressed with the number format, and the range and space of the data values to be expressed may be determined differently depending on the application.

A method of expressing a data value in the format shown in FIG. 1 is described next.

Since the length of the exponent is fixed, when the number of cases of the exponent is e, ceil (log₂e) bits are needed (here, e is a quantity rather than the mathematical constant e). For example, if the number of cases of the exponent is “8”, then “3” bits are needed.

In the mantissa, the numbers after the first-occurring “1” may be continued after the exponent as they are, and “0” may be stored in the mapping table as a predetermined exponent code. Depending on the value of the exponent, the mantissa may be stored as a separate mapping table or fixed as hardware to indicate how many bits the mantissa has.

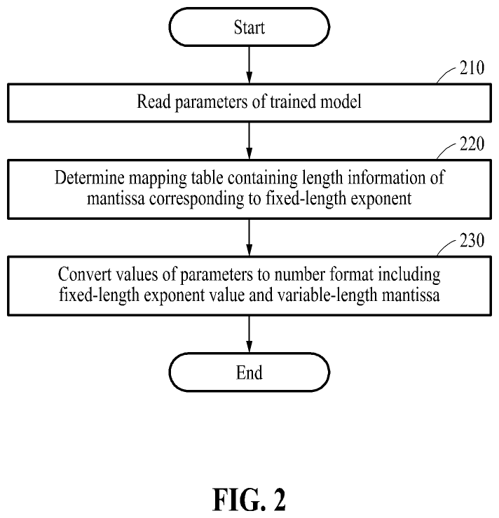

FIG. 2 illustrates a method of converting a parameter by a neural processor apparatus, according to one or more embodiments.

A neural processor apparatus (hereinafter, the “apparatus”) may convert parameters of a neural network, e.g., to the format of FIG. 1, through operations 210 to 230.

In operation 210, the neural processor apparatus reads the parameters of a trained model. The parameters may correspond to parameters of at least one layer of the trained model, for example. In some embodiments, the parameters may be weights of respective inter-node connections.

In operation 220, the neural processor apparatus determines a mapping table containing mantissa-length information of mantissas respectively corresponding to fixed-length exponents. That is to say, the mapping table may map different fixed-length exponents to respectively corresponding mantissa-lengths. The mantissa-length information of a mantissa may indicate the number of bits with which to express a corresponding mantissa.

In the mapping table, the mantissa-lengths mapped to the exponents may be automatically determined based on the distribution of the parameters, or may be determined through experimental analysis. For example, for parameters with a high distribution (i.e., more frequently occurring), the mapping table may map to greater mantissa lengths; bits having a lot of length information of the mantissa may be allocated so that more net mantissa information is expressed, and small numbers may be omitted within large numbers.

In operation 230, the neural processor apparatus converts values of the parameters from a same format of the values to be converted (e.g., a standard format such as FP16 or some other format), to a number format with a fixed-length exponent value and a variable-length mantissa. Regarding how the exponent may be converted, reduction may be based on the possible combinations of the exponent part. For example, if there are 8 possibilities of the exponent part, a 3-bit combination can be generated such as 000, 001, 010 . . . , and a one-to-one mapping may be established for each, resulting in a new/shorter exponent.

A parameter may be converted to the variable-length-mantissa number format previously described with reference to FIG. 1. First, a parameter may be divided into an exponent and a mantissa, and the number of unique exponents (e) may be obtained. The value of the exponent may be encoded to ceil (log₂e) bits with the obtained number of unique exponents.

Thereafter, the mantissas of respective parameters may be expressed according to the number of mantissa bits indicated by referring to the mapping table, which indicates how many bits (excluding the first occurrence of a “1”, from the left) are to be used to express the mantissas for the respectively corresponding exponent values. In this way, a number format may be formed with a set of the encoded exponent and the mantissa excluding the first “1”.

As a result of the conversion, a mapping table indicating the length of the mantissa, encoded bits, and values corresponding to the number format may be output, in cases where the mapping table is not computed or provided beforehand. Here, “value” is a value represented by the set that includes the encoded exponent part and the mantissa part excluding the first 1 (“value” does not refer the mapped value).

To summarize, the mapping table may map specific statistically-determined bit patterns of exponents to respectively corresponding mantissa lengths. It is possible, depending on the distribution of exponent values, that the converted exponents are compressed as compared to their original form.

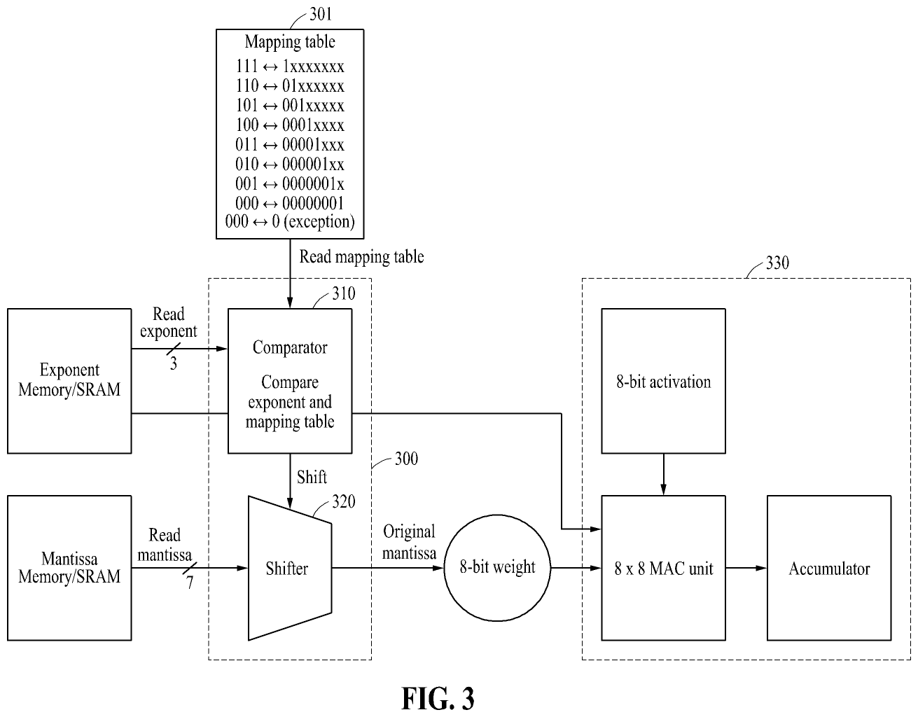

FIG. 3 illustrates a neural network processor apparatus for converting a previously-converted parameter back to a form computable by an arithmetic unit, according to one or more embodiments. The arithmetic unit may, in some implementations, be an arithmetic logic unit (ALU) or similar component of a processor. In the example of FIG. 3, the exponents of previously-converted values are expressed with three bits.

A neural network processor apparatus 300 may include a comparator 310 configured to read the 3-bit (for example) exponent of a previously-converted parameter (a parameter in the variable-mantissa format), use the exponent as an index into a mapping table 301, and thus obtain the mantissa-length information corresponding to (mapped to) the value of the exponent. A shifter 320 may be configured to read the mantissa (e.g., 7 bits) of the previously-converted parameter and convert the value of the mantissa to a value/form before the conversion (or, to the format prior to conversion) based on the obtained mantissa-length information. For example, the 7-bit converted mantissa may be converted, by corresponding shifting, to its original 8-bit mantissa.

To summarize, the comparator 310 may obtain the mantissa-length information of the mantissa according to the value of its exponent by referring to the mapping table 301. Conversion of a parameter from the variable-length-mantissa format to the original/standard format may be referred to as reverse conversion, or, reversion.

The value of the exponent and the value of the mantissa (from the parameter in its converted (variable-length-mantissa) form) may be provided to the comparator 310 and the shifter 320, respectively, through a memory (e.g., static random-access memory (SRAM), etc.) in which the exponent and the mantissa are stored separately.

The comparator 310 may verify how much the mantissa is compressed by looking up the value of the exponent in the mapping table 301 corresponding thereto. The mapping table 301 indicates how many bits with which the mantissa is expressed (in converted form), according to the value of the exponent. The mapping table 301 may indicate how many bits are needed to express the remaining values except (after) the first occurrence of “1” in the mantissa before conversion. To elaborate, as explained above, based on the bit combinations generated according to the possible values of the exponent part, each is mapped on a one-to-one basis. Using this mapping information, the encoded mapping may then be converted back to the original exponent part.

The shifter 320 may revert the mantissa by converting the value of the mantissa (from its previously-converted form) to the form the mantissa had before being converted (e.g., a fixed-length mantissa possibly according to a standard floating point format) by shifting the value of the previously-converted mantissa by the mantissa-length information mapped to the value of the exponent. To explain further, the read mantissa of the shifter has a fixed length (maximum mantissa length). If a table indicates that a shorter mantissa length is needed, the shifter pads with zeros to reach the maximum length (meaning the length increases, but only with leading zeros, not the mantissa itself). For shorter mantissa lengths, the read mantissa may contain multiple mantissas of different values (data) that are not aligned (starting from the rightmost, LSB). For example, if a 7-bit value 11001 01 is input and only 11001 is needed, it shifts (along with a leading 1) to produce 001 11001.

Thereafter, the converted value of the mantissa and the converted value of the exponent may be input into an arithmetic unit 330 and be in a form suitable for computation thereon by the arithmetic unit 330 (e.g., a standard form such as FP16). The arithmetic unit 330 may obtain the reverted pre-conversion parameter value using the values of the mantissa and exponent of the parameter as converted by the shifter 320, and, for example, may perform a MAC operation with the reverted parameter.

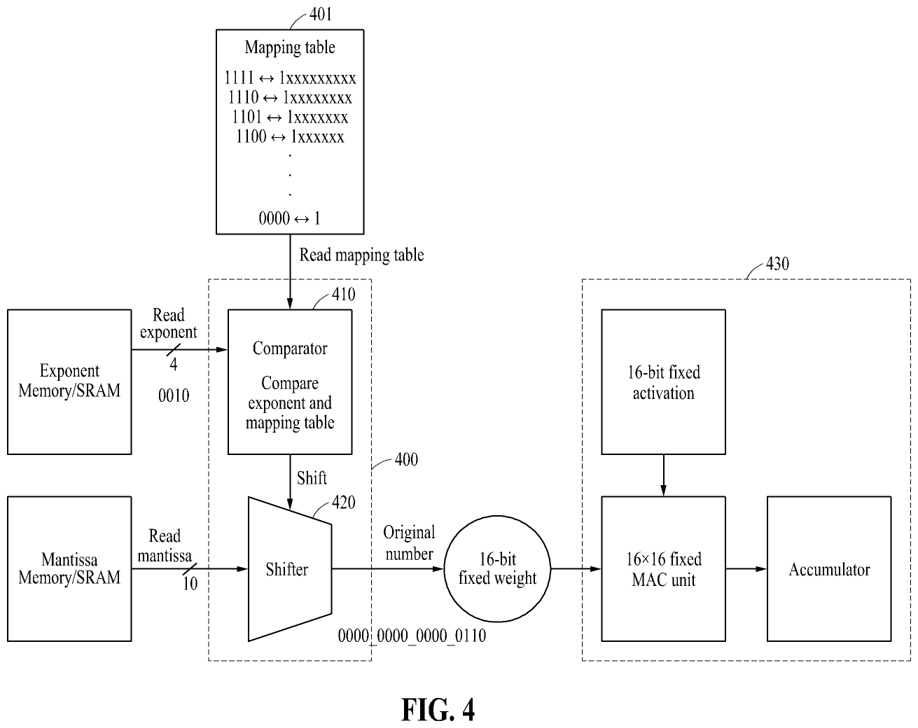

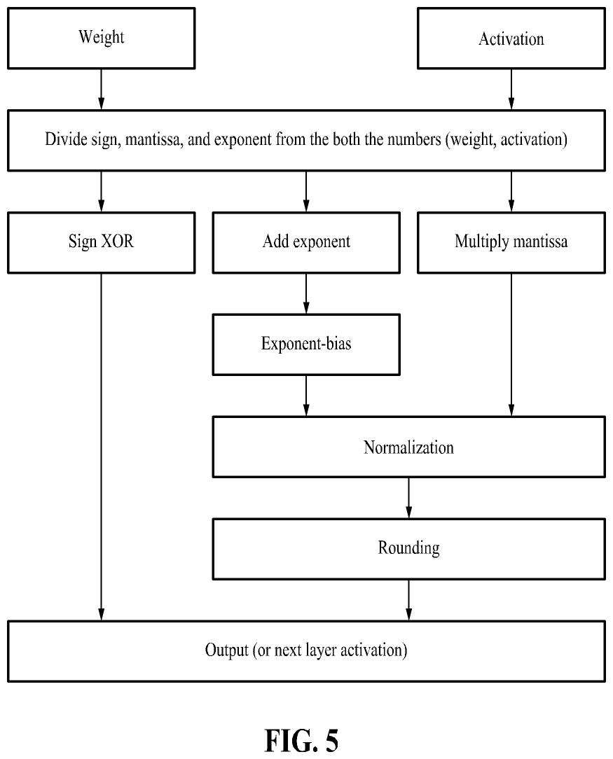

FIG. 4 illustrates another neural network processor apparatus for converting a parameter back to a form computable by an arithmetic unit, according to one or more embodiments. The conversion/reversion-related components of the neural network processor apparatuses of FIGS. 4 and 5 may be provided in the same neural network processor apparatus, or in separate neural network processor apparatuses.

The structure shown in FIG. 4 is also for converting a converted parameter back to a parameter in its pre-conversion form (e.g., into the parameter's pre-conversion fixed-point form). A case where the exponent of the converted format is 4 bits is described in the example of FIG. 4. In the example of FIG. 4, the converted parameter may have been converted from an original fixed-point number format.

A neural network processor apparatus 400 may include a comparator 410 configured to (i) read the real (data) part of a parameter converted by fixed point and (ii) obtain exponent shift information of the real part mapped to a mapping table 401 according to the value of the real part. The apparatus may also include a shifter 420 configured to read the decimal (fractional) part of the parameter converted by fixed point and convert the value of the decimal part to a pre-conversion parameter by summing the value of the decimal part and the value of the real part whose exponent shifted by the exponent shift information.

According to FIG. 4, the parameter value before conversion for the parameter converted to a fixed-point form may be obtained from the shifter 420.

The mapping table 401 may map exponent shift information for the real part according to the value of the real part. The exponent shift information may be provided in a form where the exponential shift information decreases by one digit as the value of the real part decreases. For example, for an 8-bit parameter, a mapping table that decreases in the form of 1xxxxxxx, 1xxxxxx, 1xxxxx, . . . , 1 as the real part value from 111 to 000 decreases may be provided.

Alternatively, the mapped value of the mapping table 401 may be expressed as indicating the number of digits to be moved to the right of the real part, depending on the value of the real part. For example, if the value of the real part is 010, the value of the decimal part may be expressed after 1 digit of the real part.

The shifter 420 may shift the exponent of the real part based on the value of the real part and the exponent shift information of the real part obtained from the comparator 410, and obtain a 16-bit parameter before conversion by summing the value of the decimal part as it is.

Information on the real part and the decimal part may be separately stored in a memory such as SRAM, and the separately stored information may be input into the comparator 410 and the shifter 420, respectively.

Parameters before conversion into a computable form may be input into an arithmetic unit 430 to perform a MAC operation thereon. The arithmetic unit 430 may perform a MAC operation using the parameters before conversion by the shifter 320.

FIG. 5 illustrates an operation of an arithmetic unit, according to one or more embodiments.

A method of performing a MAC operation using a 16-bit parameter by an arithmetic unit will be described.

In the example of FIG. 5, a weight may be set as a parameter before conversion thereof, and a MAC operation may be performed on an activation that is input.

Assuming that the data format of the weight and activation is a binary format of half-precision floating point (FP16, as per an IEEE standard, for example), the weight may be assumed to be 1.25:0011_1101_0000_0000, and the activation may be assumed to be 2.125:0100_0000_1000_0000.

Analyzing the example weight, the sign is indicated by the leftmost (most significant) bit and is 0, the exponent is indicated by the next 5 bits and is 01111, the mantissa is represented by the remaining bits and is 0100000000. This value may be expressed as 01111 for the exponent and 0000000101 for the converted mantissa in a mapping table. From the mapping table, the mantissa may be converted to 01 and stored in a memory.

To be input into an arithmetic unit, the pre-conversion parameter is obtained from the converted parameter. The exponent 01111 may be obtained from the converted parameter, and it may be verified that the shift information of the mantissa is 8 digits according to the mapping table.

After converting the weight to the pre-conversion value, an operation may be performed as shown in FIG. 5. Each of the weight and the activation is divided into the sign, exponent, and mantissa, and then, an operation is performed on each.

An XOR operation may be performed on the sign, an addition may be performed on the exponent, and a multiplication may be performed on the mantissa. Thereafter, an output may be obtained by performing normalization and rounding on the operation result of the exponent and the operation result of the mantissa.

The obtained output may be the activation for the next layer, or may be the final output value.

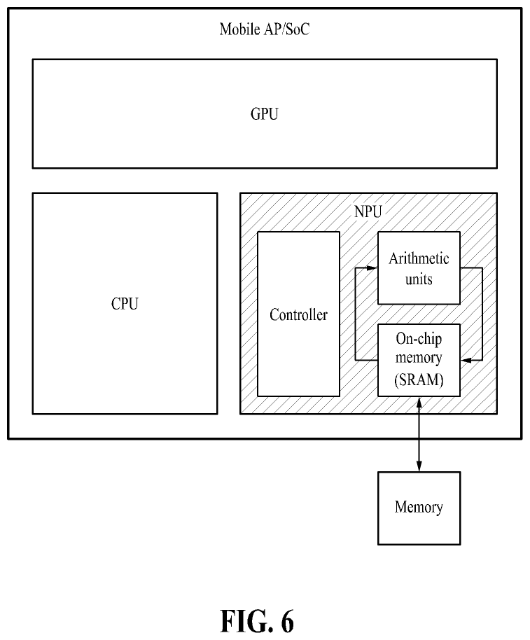

FIG. 6 illustrates a smartphone AP, according to one or more embodiments.

FIG. 6 schematically shows an example of an internal configuration of a smartphone AP. The smartphone AP may include a neural processing unit (NPU). The NPU may be equipped to compute deep learning parameters stored in the number format described above.

By configuring an NPU arithmetic unit to compute a number format expressed by a fixed exponent and a variable mantissa, multiplication operations may be processed for the formats defined through the description of FIGS. 1 to 5, including the existing fixed point format.

The distribution of the deep learning parameters may be stored in an on-chip memory such as SRAM in an efficient size of a number format expressed by a fixed exponent and a variable mantissa, and the accuracy, computational efficiency, storage efficiency, and space efficiency may be flexibly adjusted.

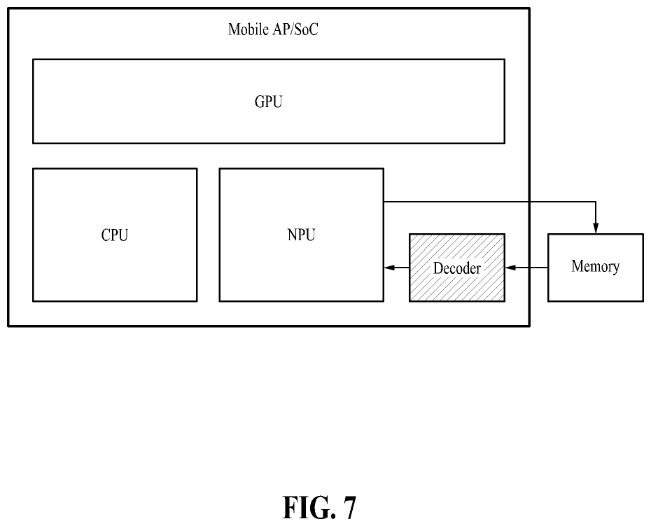

FIG. 7 illustrates another smartphone AP, according to one or more embodiments.

Unlike FIG. 6, a smartphone AP of FIG. 7 has a configuration in which encoding is used by a component such as an AP of a smartphone and a decoder 701 is embedded. By configuring a processor in this way, it is possible to store only the number format in the manner of the example without modifying the configuration of the arithmetic unit.

Even if the same fixed-point expression space is stored, due to the distribution characteristics of deep learning parameters, it may be stored in the memory in a small size.

Since the NPU of the smartphone consumes a significant amount of power to read parameter information from an external memory when performing a neural network operation (e.g., an inference), reading converted parameters may reduce the traffic and power consumption for parameters through the parameters of the example expressed with a small number of bits.

If the neural network processing rate decreases due reading parameters, it is possible to improve the neural network processing rate with respect to reading parameters.

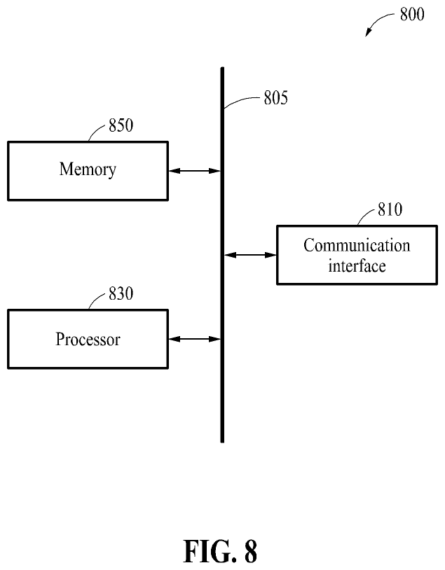

FIG. 8 illustrates a processor apparatus for converting a parameter, according to one or more embodiments.

Referring to FIG. 8, a processor apparatus 800 according to an example may include a communication interface 810, a processor 830, and a memory 850. The communication interface 810, the processor 830, and the memory 850 may communicate with each other through a communication bus 805.

The communication interface 810 may receive parameters.

The processor 830 may convert the parameters received through the communication interface 810 to a predetermined number format. The processor 830 may convert the obtained parameters into a number format including a fixed exponent and a variable mantissa by referring to a mapping table.

The memory 850 may store a variety of information generated in a processing operation of the processor 830 described above. In addition, the memory 850 may store a variety of data and programs. The memory 850 may include a volatile memory or a non-volatile memory. The memory 850 may include a large-capacity storage medium such as a hard disk to store a variety of data.

In addition, the processor 830 may perform the at least one method described above with reference to FIGS. 1 to 7 or an algorithm corresponding to the at least one method. The processor 830 may be a hardware-implemented data processing device having a circuit that is physically structured to execute desired operations. The desired operations may include, for example, code or instructions included in a program. The processor 830 may be implemented as, for example, a central processing unit (CPU), a graphics processing unit (GPU), or a neural network processing unit (NPU). The hardware-implemented processor apparatus 800 may include, for example, a microprocessor, a central processing unit (CPU), a processor core, a multi-core processor, a multiprocessor, an application-specific integrated circuit (ASIC), and a field-programmable gate array (FPGA).

The processor 830 may execute the program (code/instructions) and control the processor apparatus 800. Program code to be executed by the processor 830 may be stored in the memory 850.

The computing apparatuses, the processors, the memories, the image sensors, the displays, the information output system and hardware, the storage devices, and other apparatuses, devices, units, modules, and components described herein with respect to FIGS. 1-8 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A neural processor apparatus comprising:
a comparator configured to read a value of a fixed-length exponent of a previously-converted parameter value and obtain mantissa-length information of a mantissa, wherein the mantissa-length information is obtained from a mapping table based on being mapped to the value of the exponent;
a shifter configured to read the mantissa of the previously-converted parameter value and use the mantissa-length information to convert a structure of the previously-converted parameter value; and
the mapping table, in which the mantissa-length information of the mantissa is mapped to the value of the exponent.

2. The neural processor apparatus of claim 1, wherein in the mapping table, the mapping of the mantissa-length information to the value of the exponent is determined according to a distribution of neural network parameters.

3. The neural processor apparatus of claim 1, wherein the shifter is further configured to shift the position of the value of the mantissa based on the mantissa-length information of the mantissa.

4. The neural processor apparatus of claim 1, wherein the shifter is further configured to add “0” according to a number of bits allocated to express the previously-converted parameter value.

5. The neural processor apparatus of claim 1, wherein
based on a method of expressing the previously-converted parameter value,
the comparator is further configured to obtain exponent shift information of a fixed-length real part mapped to a value of the real part of the parameter value, and
the shifter is further configured to shift the value of the real part according to the exponent shift information of the real part.

6. The neural processor apparatus of claim 5, wherein the shifter is further configured to sum a value of a decimal part of the parameter value and the value of the real part shifted by the exponent shift information of the real part.

7. The neural processor apparatus of claim 1, wherein the comparator and the shifter are configured to read the exponent and the mantissa of the previously-converted parameter from a static random-access memory (SRAM), respectively.

8. The neural processor apparatus of claim 1, wherein for a multiply and accumulate (MAC) operation, the parameter value with the converted structure and the value of the exponent are input into an arithmetic unit.

9. An operating method of a processor apparatus, the operating method comprising:
reading parameters of a trained model;
based on a distribution of the parameters, determining a mapping table mapping mantissa-lengths to respectively corresponding fixed-length exponents; and
based on the mapping table, converting values of the parameters to have a number format comprising a fixed-length exponent and a variable-length mantissa.

10. The operating method of claim 9, wherein in the mapping table, the mantissa-lengths are determined according to the distribution of the parameters.

11. The operating method of claim 9, further comprising:
recording into a memory the exponent values and the mantissa values of the parameters as converted to the number format.

12. The operating method of claim 9, wherein the converting of the values of the parameters to the number format comprising the fixed-length exponent value and the variable-length mantissa comprises converting remaining values after the first occurrence of a “1” in the variable-length mantissa to the number format.

13. A non-transitory computer-readable storage medium storing instructions that, when executed by a processor, cause the processor to perform the operating method of claim 9.

14. A processor apparatus comprising:
one or more processors;
a memory; and
one or more programs stored in the memory and configured to cause the one or more processors to perform a process comprising:
reading parameters of a trained model;
based on a statistical distribution of the parameters, determining a mapping table mapping mantissa-lengths to respectively corresponding fixed-length exponents; and
based on the mapping table, converting values of the parameters to have a number format comprising a fixed-length exponent and a variable-length mantissa, wherein the converting is performed according to the values of the parameters.

15. The processor apparatus of claim 14, wherein in the mapping table, the mantissa-lengths are determined according to the statistical distribution of the parameters.

16. The processor apparatus of claim 14, wherein the process further comprises:
recording into the memory the exponent values and the mantissa values of the parameters as converted to the number format.

17. The processor apparatus of claim 14, wherein the converting of the values of the parameters to the number format comprising the fixed-length exponent value and the variable-length mantissa comprises converting remaining values after the first occurrence of a “1” in the variable-length mantissa to the number format.
